(19) United States
(12) Patent Application Publication
(10) Pub. No.: US 2021/0036304 A1
(43) Pub. Date: Feb. 4, 2021

(54) ELECTRODE STRUCTURE AND SECONDARY BATTERY INCLUDING THE SAME

(71) Applicant: Samsung Electronics Co., Ltd., Suwon-si (KR)

(72) Inventors: Kyounghwan Kim, Seoul (KR); Hwiyeol Park, Ansan-si (KR); Jeongkuk Shon, Hwaseong-si (KR); Junhyeong Lee, Seoul (KR); Sungjin Lim, Suwon-si (KR); Huisu Jeong, Seongnam-si (KR); Jin S. HEO, Suwon-si (KR)

(21) Appl. No.: 16/944,760

(22) Filed: Jul. 31, 2020

(30) Foreign Application Priority Data
Jul. 31, 2019 (KR) 10-2019-0093371

(51) Int. Cl. H01M 4/13; H01M 4/36; H01M 4/70; H01M 10/052

(52) U.S. Cl. CPC H01M 4/13; H01M 4/366; H01M 2004/028; H01M 10/052; H01M 4/70

(57) ABSTRACT

An electrode structure includes: a current collector layer including a current collector including a feature, wherein the current collector is within the current collector layer, an active material layer provided on the current collector layer, and an adhesive pattern including an adhesive and disposed in the feature of the current collector, wherein the adhesive pattern extends between the current collector layer and the active material layer, and the active material layer is fixed on a top surface of the current collector layer by the adhesive pattern.

### CROSS-REFERENCE TO RELATED APPLICATION

This application claims priority to and the benefit of Korean Patent Application No. 10-2019-0093371, filed on Jul. 31, 2019, in the Korean Intellectual Property Office, and all the benefits accruing therefrom under 35 U.S.C. § 119, the content of which is incorporated herein in its entirety by reference.

### BACKGROUND

### 1. Field

The present disclosure relates to an electrode structure, and a secondary battery including the electrode structure.

### 2. Description of the Related Art

Unlike a primary battery that may not be charged, a secondary battery may be charged and discharged. Secondary batteries are widely used in the field of advanced electronic devices, such as cellular phones, notebook computers, camcorders.

In particular, a lithium secondary battery has advantages, for example, a higher voltage and higher specific energy, than a nickel-cadmium battery or a nickel-hydrogen battery. Also, the demand for the lithium secondary battery is increasing.

### SUMMARY

Provided is an electrode structure, and a secondary battery having improved electrical characteristics, reduced thickness, and improved structural stability compared to a nickel-cadmium battery or a nickel-hydrogen battery.

Additional aspects will be set forth in part in the description which follows and, in part, will be apparent from the description, or may be learned by practice of the presented embodiments of the disclosure.

According to an aspect of an embodiment, an electrode structure includes: a current collector layer including a current collector including a feature, wherein the current collector is within the current collector layer; an active material layer on the current collector layer; and an adhesive pattern including an adhesive and disposed in the feature of the current collector; wherein the adhesive pattern extends between the current collector layer and the active material layer, and the active material layer is fixed on a top surface of the current collector layer by the adhesive pattern.

A distance between a top surface of the adhesive pattern and a bottom surface of the current collector layer may be greater than a thickness of the current collector layer.

The adhesive pattern may extend from the top surface of the current collector layer in a direction towards a bottom surface of the current collector layer.

A maximum width of the adhesive pattern on the top surface of the current collector layer may be greater than a maximum width of the adhesive pattern in the feature of the current collector.

The adhesive pattern may pass through the current collector layer, and the adhesive pattern may extend in a direction from a top surface of the current collector to a bottom surface of the current collector.

The adhesive pattern may be between the active material layer and the current collector.

The electrode structure may further include an upper active material layer and a lower active material layer wherein the lower active material layer is on a side of the current collector layer opposite the upper active material layer, wherein the lower active material layer may be fixed on a bottom surface of the current collector layer by the adhesive pattern.

A distance between the bottom surface of the adhesive pattern and the top surface of the current collector layer may be greater than the thickness of the current collector layer.

At least one of a bottom surface of the upper active material layer and a top surface of the lower active material layer may have a corrugated structure.

The feature may extend through the current collector from the top surface of the current collector to the opposite bottom surface of the current collector.

The feature may not extend through the current collector from the top surface of the current collector to the opposite bottom surface of the current collector.

The adhesive pattern may include a first adhesive pattern on the top surface of the current collector and a second adhesive pattern on the bottom surface of the current collector.

A thickness of the adhesive pattern may be less than the thickness of the current collector layer.

The electrode structure wherein the active material layer may further include the upper active material layer on the top surface of the current collector layer opposite the lower active material layer and a lower adhesive pattern disposed in the feature of the current collector, wherein the lower adhesive pattern may extend between the current collector layer and the lower active material layer, a thickness of the lower adhesive pattern may be less than the thickness of the current collector layer, and the lower active material layer may be fixed on the bottom surface of the current collector layer by the lower adhesive pattern.

The adhesive pattern and the lower adhesive pattern respectively may be provided in plurality.

The electrode structure may further include a conductive film on the bottom surface of the upper active material layer.

The conductive film may conformally extend along the bottom surface of the upper active material layer.

According to an aspect of an embodiment, a secondary battery includes: a separation film; an anode structure on the separation film; and a cathode structure on a side of the separation film opposite the anode structure, wherein the cathode structure includes a current collector layer including a current collector including a feature, wherein the current collector is within the current collector layer; an active material layer on the current collector layer, and an adhesive pattern including an adhesive and disposed in the feature of the current collector, wherein the adhesive pattern extends between the current collector layer and the active material layer, and the active material layer is fixed on the current collector layer by the adhesive pattern.

The adhesive pattern may extend from a top surface of the current collector layer in a direction towards a bottom surface of the current collector.

The secondary battery may further include an upper active material layer and a lower active material layer, the lower active material layer on a side of the current collector layer opposite to the upper active material layer, the adhesive pattern may extend from the current collector layer to the lower active material layer, and the lower active material layer is fixed on the bottom surface of the current collector layer by the adhesive pattern.

A thickness of the adhesive pattern may be less than the thickness of the current collector layer.

According to an aspect of an embodiment, a secondary battery may include: a solid electrolyte membrane; an anode structure provided on the solid electrolyte membrane; and a cathode structure provided on the solid electrolyte membrane and opposite the anode structure, wherein the cathode structure includes a current collector layer including a current collector including a feature, wherein the current collector is within the current collector layer; an active material layer provided on the current collector layer; and an adhesive pattern including an adhesive and disposed in the feature of the current collector, wherein the adhesive pattern extends between the current collector layer and the active material layer, and the active material layer is fixed on the current collector layer by the adhesive pattern.

The secondary battery may further include an upper active material layer and a lower active material layer, the lower active material layer on a side of the current collector layer opposite the upper active material layer, the adhesive pattern may extend from the current collector layer to the lower active material layer, and the lower active material layer is fixed on a bottom surface of the current collector layer by the adhesive pattern.

A thickness of the adhesive pattern may be less than the thickness of the current collector layer.

Also disclosed is a method of making an electrode structure, the method including: providing a current collector layer including a current collector including a feature; disposing an adhesive pattern in the feature and on the current collector; and disposing an active material layer on the current collector layer, wherein the adhesive pattern extends from the current collector layer to the active material layer, and the active material layer is fixed on a surface of the current collector layer by the adhesive pattern.

### BRIEF DESCRIPTION OF THE DRAWINGS

The above and other aspects, features, and advantages of this disclosure will be more apparent and more readily appreciated from the following description of the embodiments, taken in conjunction with the accompanying drawings, in which:

FIG. 1 is a diagram of an embodiment of an electrode structure;

FIG. 2 is an enlarged view of portion AA of FIG. 1;

FIG. 3 is a diagram of an embodiment of an electrode structure;

FIG. 4 is an enlarged view of region BB of FIG. 3;

FIG. 5 is a diagram of an embodiment of an electrode structure

FIG. 6 is an enlarged view of region CC of FIG. 5;

FIG. 7 is a diagram of an embodiment of an electrode structure;

FIG. 8 is an enlarged view of region DD of FIG. 7;

FIG. 9 is a diagram of an embodiment of an electrode structure;

FIG. 10 is a diagram of an embodiment of an electrode structure;

FIG. 11 is a plan view of an embodiment of an adhesive pattern showing a top surface of a current collector layer;

FIG. 12 is a plan view of an embodiment of an adhesive pattern showing a top surface of a current collector layer;

FIG. 13 is a diagram of an embodiment of a secondary battery; and

FIG. 14 is a diagram of an embodiment of a secondary battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The present disclosure, described below, may be variously modified and may have various shapes, so examples of which are illustrated in the accompanying drawings and will be described in detail with reference to the accompanying drawings. However, it should be understood that the exemplary embodiments according to the concept of the present disclosure are not limited to the embodiments which will be described hereinbelow with reference to the accompanying drawings, but various modifications, equivalents, additions and substitutions are possible, without departing from the scope and spirit of the present disclosure.

The terminology used herein is for the purpose of describing particular embodiments only and is not intended to restrict the present disclosure. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof. As used herein the term “/” may be interpreted as “and” or “or” including any and all combinations of one or more of the associated listed items depending on the situation. “or” means “and/or.”

In the drawings, diameters, lengths, and thicknesses are enlarged or reduced in order to clearly illustrate various components, layers, and regions. Like reference numerals refer to like elements throughout the specification. It will be understood that when an element or layer is referred to as being “on” or “above” another element or layer, the element or layer may be directly on another element or layer or intervening elements or layers.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, the singular forms are intended to include the plural forms as well, unless the context clearly indicates otherwise. It should be understood that, when a part “comprises” or “includes” an element in the specification, unless otherwise defined, it is not excluding other elements but may further include other elements.

Also, in the specification, the term “units” or “ . . . modules” denote units or modules that process at least one function or operation, and may be realized by hardware, software, or a combination of hardware and software.

Disclosed is an electrode structure comprising: a current collector layer comprising a current collector comprising a feature, wherein the current collector is within the current collector layer; an active material layer on the current collector layer; and an adhesive pattern comprising an adhesive and disposed in the feature of the current collector, wherein the adhesive pattern extends between the current collector layer and the active material layer, and the active material layer is fixed on a surface of the current collector layer by the adhesive pattern.

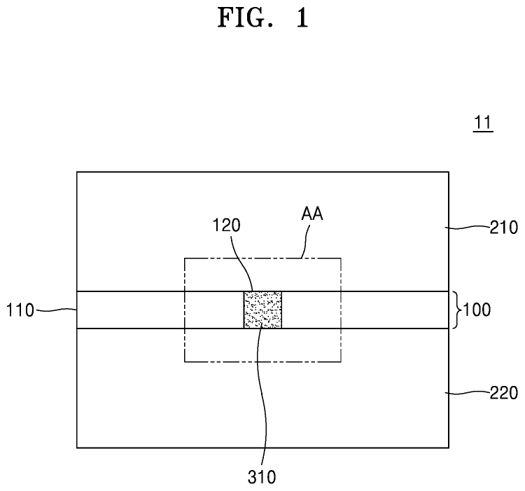

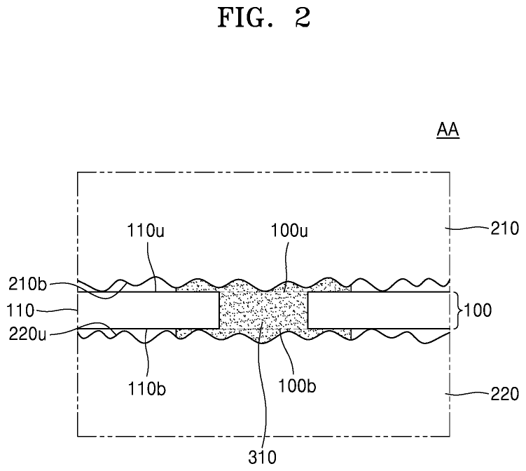

FIG. 1 is a diagram of an electrode structure according to an embodiment. FIG. 2 is an enlarged view of region AA of FIG. 1.

Referring to FIGS. 1 and 2, an electrode structure 11 including a current collector layer 100 comprising a current collector 110 comprising a feature 120 is shown. The current collector 110 is within the current collector layer 100, and a through adhesive pattern 310, comprising an adhesive, is disposed in the feature of the current collector layer. An upper active material layer 210, and a lower active material layer 220, may be provided. For example, the electrode structure 11 may be included in a cathode of a lithium secondary battery.

The current collector layer 100 comprises a current collector 110, e.g., a cathode current collector of a secondary battery. The current collector 110 may include a conductive material. For example, the current collector 110 may include copper (Cu), gold (Au), platinum (Pt), silver (Ag), zinc (Zn), aluminum (Al), magnesium (Mg), and titanium (Ti), iron (Fe), cobalt (Co), nickel (Ni), germanium (Ge), indium (In), lead (Pb), or a combination thereof.

The feature 120 of the current collector 110 may be a through hole, e.g., a product of punching, or may be an indentation, e.g., a product of embossing the current collector.

The upper active material layer 210 may be provided on a top surface 100u of the current collector layer 100. The upper active material layer 210 may contact the current collector 110. The upper active material layer 210 may include a cathode active material. For example, the upper active material layer 210 may include LiCoO₂ (LCO), LiNiaCobMn_{1-(a+b)}O₂ (NCM) wherein 0≤a≤1, and 0≤b≤1, LiNiaCobAl_{1-(a+b)}O₂ (NCA) wherein 0≤a≤1 and 0≤b≤1, LiMn₂O₄ (LMO), LiFePO₄ (LFP), or a combination thereof. The upper active material layer 210 may be manufactured by a sintering process. The upper active material layer 210 may not include a binder and a conductive material. A bottom surface 210b of the upper active material layer 210 may have a corrugated structure.

The lower active material layer 220 may be provided on a bottom surface 100b of the current collector layer 100. The upper active material layer 210 may contact the current collector 110. The lower active material layer 220 may include a cathode active material. For example, the lower active material layer 220 may include LiCoO₂ (LCO), LiNiaCobMn_{1-(a+b)}O₂ (NCM) wherein 0≤a≤1 and 0≤b≤1, LiNiₐCo_{b}Al_{1-(a+b)}O₂ (NCA) wherein 0≤a≤1, and 0≤b≤1, LiMn₂O₄ (LMO), LiFePO₄ (LFP), or a combination thereof. The lower active material layer 220 may be manufactured by a sintering process. The lower active material layer 220 may not include a binder and a conductive material. A top surface 220u of the lower active material layer 220 may have a corrugated structure.

The through adhesive pattern 310 may be disposed in the feature 120 of the current collector 110. The through adhesive pattern 310 may pass through the current collector layer 100. For example, the through adhesive pattern 310 may extend in a direction from the top surface 100u of the current collector layer 100 to a bottom surface 100b of the current collector layer 100. For example, the through adhesive pattern 310 may extend in a direction perpendicular to the top surface 100u of the current collector layer 100. A top surface of the through adhesive pattern 310 may be on the top surface 100u of the current collector layer 100. A bottom surface of the through adhesive pattern 310 may be on the bottom surface 100b of the current collector layer 100.

The through adhesive pattern 310 may extend from an inner side of the current collector layer 100 to the top surface 100u and the bottom surface 100b of the current collector layer 100. A portion of the through adhesive pattern 310 may be provided in the current collector layer 100. Another portion of the through adhesive pattern 310 may be provided on the top surface 100u of the current collector layer 100. Still another portion of the through adhesive pattern 310 may be provided on the bottom surface 100b of the current collector layer 100. The through adhesive pattern 310 may include a binder material. For example, the through adhesive pattern 310 may include an insulating binder material (for example, a polymer-based binder material) or a conductive binder material (for example, a soldering paste).

A distance between the top surface of the through adhesive pattern 310 and the bottom surface 100b of the current collector layer 100 may be greater than a thickness of the current collector layer 100. A distance between a lowermost bottom surface of the through adhesive pattern 310 and the top surface 100u of the current collector layer 100 may be greater than the thickness of the current collector layer 100. The thickness of the current collector layer 100 may be a distance between the top surface 100u of the current collector layer 100 and the bottom surface 100b of the current collector layer 100. A maximum width of the through adhesive pattern 310 may be greater than a maximum width of the through adhesive pattern 310 in the current collector layer 100.

The through adhesive pattern 310 may extend between the bottom surface 210b of the upper active material layer 210 and the top surface 100u of the current collector layer 100. The through adhesion pattern 310 between the upper active material layer 210 and the current collector layer 100 may directly contact the bottom surface 210b of the upper active material layer 210 and the top surface 100u of the current collector layer 100. The upper active material layer 210 may be fixed on the top surface 100u of the current collector layer 100 by the through adhesive pattern 310. For example, the upper active material layer 210 may be adhesively disposed on the top surface 100u of the current collector layer 100 by the through adhesive pattern 310.

The through adhesive pattern 310 may extend between the top surface 220u of the lower active material layer 220 and the bottom surface 100b of the current collector layer 100 including the current collector 110. The through adhesion pattern 310 between the lower active material layer 220 and the current collector layer 100 may directly contact the top surface 220u of the lower active material layer 220 and the bottom surface 100b of the current collector layer 100. The lower active material layer 220 may be fixed on the bottom surface 100b of the current collector layer 100 by the through adhesive pattern 310. For example, the lower active material layer 220 may be adhesively disposed on the bottom surface 100b of the current collector layer 100 by the through adhesive pattern 310.

The upper active material layer 210 or the lower active material layer 220 may be fixed on the current collector layer 100 by disposing an additional adhesive layer other than the through adhesive pattern 310 between the upper active material layer 210 or the lower active material layer 220 and the current collector layer 100. In this case, the electrical conductivity of a cathode structure may be reduced, and a thickness of the electrode structure may be increased.

In the present disclosure, the upper and lower active material layers 210 and 220, respectively, may be fixed on the top surface 100u and the bottom surface 100b of the current collector layer 100 by the through adhesive pattern 310, which comprises an adhesive and is disposed in the feature of the current collector layer 100 instead of the additional adhesive layer. Accordingly, the electrode structure 11 having a reduced thickness and improved electrical conductivity compared to an electrode structure of a nickel-cadmium battery or a nickel-hydrogen battery may be provided.

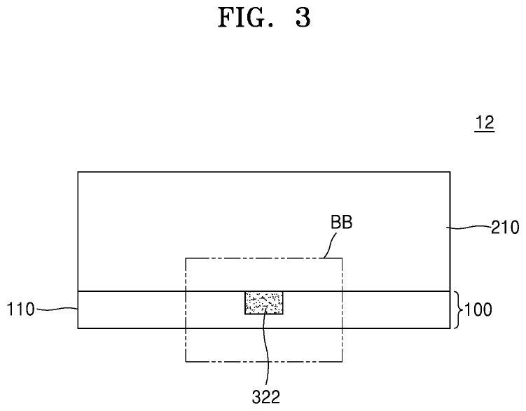

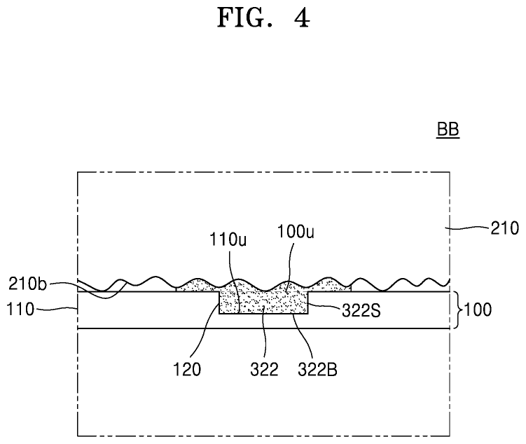

FIG. 3 is a diagram of an electrode structure 12 according to an embodiment. FIG. 4 is an enlarged view of region BB of FIG. 3. For brevity of description, substantially the same description as given with reference to FIGS. 1 and 2 may be omitted.

Referring to FIGS. 3 and 4, the electrode structure 12 including a current collector layer 100 comprising a current collector 110 comprising a feature 120, wherein the current collector 110 is within the current collector layer 100. An upper active material layer 210, and an upper buried adhesive pattern 322 comprising an adhesive and disposed in the feature of the current collector, may be provided. The current collector layer 100, the current collector 110, and the upper active material layer 210 may be substantially the same as the current collector layer 100, the current collector 110, and the upper active material layer 210 described with reference to FIGS. 1 and 2.

The upper buried adhesive pattern 322 comprising an adhesive and disposed in the feature of the current collector layer may be provided in the current collector layer 100 comprising a current collector 110 comprising a feature, wherein the current collector 110 is within the current collector layer 100. Unlike the through adhesive pattern 310 described with reference to FIGS. 1 and 2, the upper buried adhesive pattern 322 may be embedded in the feature of the current collector 110. The upper buried adhesive pattern 322 may not pass through the current collector layer 100. The upper buried adhesive pattern 322 disposed in the current collector layer 100 may have a thickness less than a thickness of the current collector layer 100 or the current collector 110. A distance between a bottom surface 322B of the upper buried adhesive pattern 322 and a top surface 100u of the current collector layer 100 may be less than a thickness of the current collector layer 100. Also, a distance between a top surface 110u of the current collector 110 and a top surface 100u of the current collector layer 100 may be less than a thickness of the current collector layer 100. A side surface 322S and the bottom surface 322B of the upper buried adhesive pattern 322 may be surrounded by the current collector 110. The upper buried adhesive pattern 322 may be in the current collector layer 100, and may extend from an inner side of the current collector layer 100 to the top surface 100u of the current collector layer 100. The upper buried adhesive pattern 322 may extend from the top surface 110u of the current collector 110 to the top surface 100u of the current collector layer 100. The upper buried adhesive pattern 322 may extend between the current collector layer 100 and the upper active material layer 210. The upper buried adhesive pattern 322 may cover the top surface 100u of the current collector layer 100. The upper buried adhesive pattern 322 may be on, e.g., directly on, e.g., cover, the top surface 110u of the current collector 110.

The upper buried adhesive pattern 322 may include a binder material. For example, the upper buried adhesive pattern 322 may include an insulating binder material (for example, a polymer-based binder material) or a conductive binder material (for example, a soldering paste). The upper active material layer 210 may be fixed on the top surface 100u of the current collector layer 100 by the upper buried adhesive pattern 322.

The present disclosure may provide the electrode structure 12 having a reduced thickness and improved electrical conductivity compared to an electrode structure of a nickel-cadmium battery or a nickel-hydrogen battery.

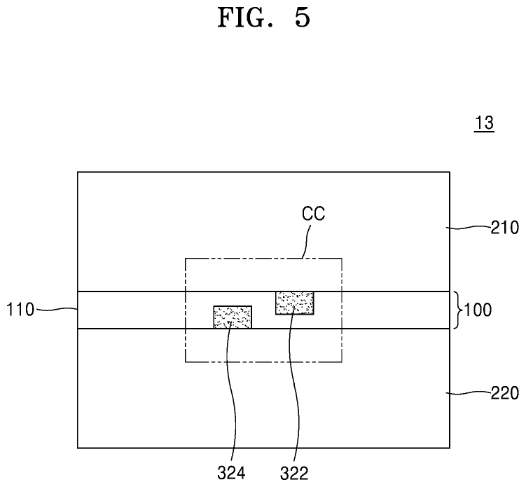

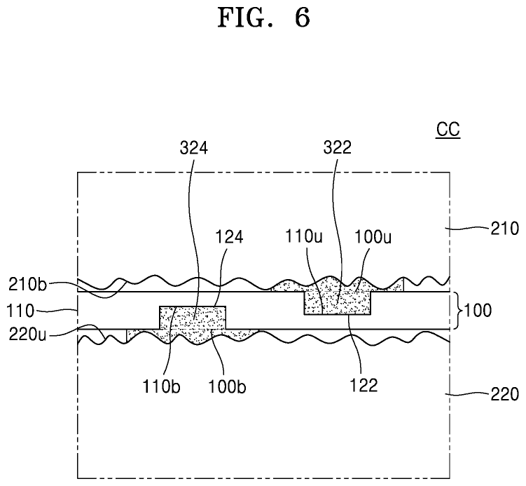

FIG. 5 is a diagram of an electrode structure 13 according to an embodiment. FIG. 6 is an enlarged view of region CC of FIG. 5. For brevity of description, substantially the same description as given with reference to FIGS. 1 through 4 has be omitted for clarity.

Referring to FIGS. 5 and 6, the electrode structure 13 including a current collector layer 100 a current collector 110 comprising an upper feature 122 and a lower feature 124. An upper active material layer 210, a lower active material layer 220, an upper buried adhesive pattern 322, and a lower buried adhesive pattern 324 comprising an adhesive and disposed in the feature of the current collector layer may be provided. The current collector layer 100, the current collector 110, the upper active material layer 210, and the lower active material layer 220 may be substantially the same as the current collector layer 100, the current collector 110, the upper active material layer 210, and the lower active material layer 220 described with reference to FIG. 1. The upper buried adhesive pattern 322 may be substantially the same as the upper buried adhesive pattern 322 described with reference to FIGS. 3 and 4. The top surface 110u of the current collector 110 may be substantially the same as the top surface 110u of the current collector 110 described with reference to FIGS. 3 and 4.

The lower buried adhesive pattern 324 comprising an adhesive and disposed in the lower feature 124 of the current collector 110 may be provided in the current collector layer 100. The lower buried adhesive pattern 324 may be in the current collector layer 100. The lower buried adhesive pattern 324 may not pass through the current collector layer 100 and the current collector 110. A thickness of the lower buried adhesive pattern 324 disposed in the current collector layer 100 may be less than a thickness of the current collector layer 100. A distance between a top surface of the lower buried adhesive pattern 324 and a bottom surface 100b of the current collector layer 100 may be less than the thickness of the current collector layer 100. A distance between a bottom surface 110b of the current collector 110 and a bottom surface 100b of the current collector layer 100 may be less than the thickness of the current collector layer 100. The current collector 110 may surround side surfaces and a top surface of the lower buried adhesive pattern 324. The lower buried adhesive pattern 324 may extend onto the bottom surface 100b of the current collector layer 100 from the inside of the current collector layer 100. The lower buried adhesive pattern 324 may extend between the current collector layer 100 and the lower active material layer 220. The lower buried adhesive pattern 324 may cover the bottom surface 100b of the current collector layer 100. The lower buried adhesive pattern 324 may cover the bottom surface 110b of the current collector 110.

The lower buried adhesive pattern 324 may include a binder material. For example, the lower buried adhesive pattern 324 may include an insulating binder material (for example, a polymer-based binder material) or a conductive binder material (for example, a soldering paste). The lower active material layer 220 may be fixed on the bottom surface 100b of the current collector layer 100 comprising a current collector 110 comprising a feature, wherein the current collector 110 is within the current collector layer 100, by the lower buried adhesive pattern 324 comprising an adhesive and disposed in the feature of the current collector layer.

The present disclosure may provide the electrode structure 13 having a reduced thickness and improved electrical conductivity compared to an electrode structure of a nickel-cadmium battery or a nickel-hydrogen battery.

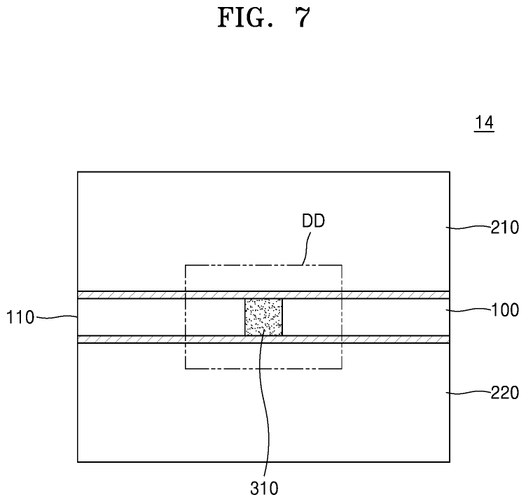

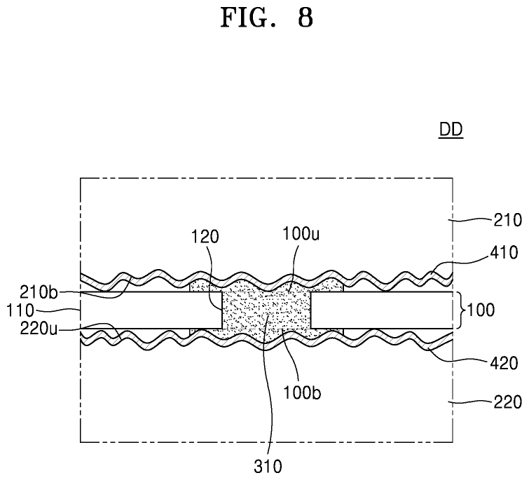

FIG. 7 is a diagram of an electrode structure 14 according to another embodiment. FIG. 8 is an enlarged view of portion DD of FIG. 7. For brevity of description, repetitive description given with reference to FIGS. 1 and 2 may be omitted for clarity.

Referring to FIGS. 7 and 8, the electrode structure 14 comprises a current collector layer 100 comprising a current collector 110 comprising a feature 120. An upper active material layer 210, an upper conductive layer 410, a lower active material layer 220, a lower conductive layer 420, and a through adhesion pattern 310 comprising an adhesive and disposed in the feature 120 of the current collector may be provided. The current collector layer 100, the current collector 110, the feature 120, the upper active material layer 210, and the lower active material layer 220 may be substantially the same as the current collector layer 100, the current collector 110, the upper active material layer 210, and the lower active material layer 220 described with reference to FIGS. 1 and 2.

An upper conductive layer 410 may be provided between the current collector layer 100 and the upper active material layer 210. The upper conductive layer 410 may be provided on a bottom surface 210b of the upper active material layer 210. The upper conductive layer 410 may cover the bottom surface 210b of the upper active material layer 210. For example, the upper conductive layer 410 may conformally extend along the bottom surface 210b of the upper active material layer 210. The upper conductive layer 410 may directly contact the through adhesive pattern 310. The upper conductive layer 410 may be fixed on the top surface 100u of the current collector layer 100. The upper conductive layer 410 may include a conductive material. For example, the upper conductive layer 410 may include a metal. The upper conductive layer 410 may increase the electrical conductivity between the current collector layer 100 and the upper active material layer 210.

The lower conductive layer 420 may be provided between the current collector layer 100 and the lower active material layer 220. The lower conductive layer 420 may be provided on a top surface 220u of the lower active material layer 220. The lower conductive layer 420 may cover the top surface 220u of the lower active material layer 220. For example, the lower conductive layer 420 may conformally extend along the top surface 220u of the lower active material layer 220. The lower conductive layer 420 may directly contact the through adhesive pattern 310. The lower conductive layer 420 may be fixed on the bottom surface 100b of the current collector layer 100. The lower conductive layer 420 may include a conductive material. For example, the lower conductive layer 420 may include a metal. The lower conductive layer 420 may increase the electrical conductivity between the current collector layer 100 and the lower active material layer 220.

In an embodiment, the upper buried adhesive pattern 322 described with reference to FIGS. 3 and 4 or the lower buried adhesive pattern 324 described with reference to FIGS. 5 and 6 may be provided instead of the through adhesive pattern 310.

The present disclosure may provide the electrode structure 14 having a reduced thickness and improved electrical conductivity compared to an electrode structure of a nickel-cadmium battery or a nickel-hydrogen battery.

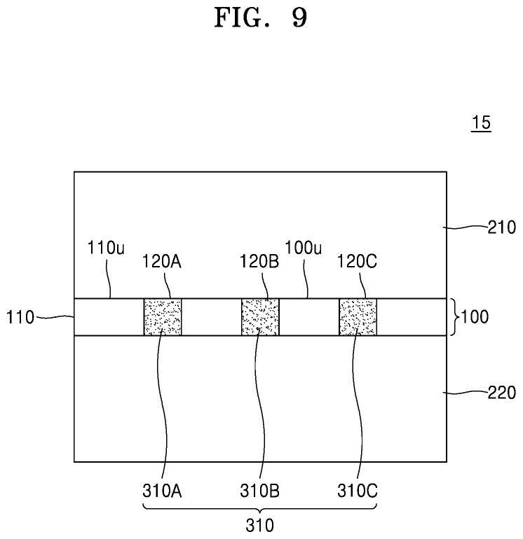

FIG. 9 is a diagram of an electrode structure 15 according to another embodiment; For brevity of description, repetitive description given with reference to FIGS. 1 through 6 may be omitted for clarity.

Referring to FIG. 9, the electrode structure 15, comprises a current collector layer 100 comprising a current collector 110 comprising first feature 120A, second feature 120B, and third feature 120C, wherein the current collector 110 is within the current collector layer 100, an upper active material layer 210, a lower active material layer 220, and a plurality of through adhesion patterns 310, e.g., 310A, 310B, and 310C, comprising an adhesive and disposed in the feature of the current collector layer may be provided. The current collector layer 100, the current collector 110, the upper active material layer 210, and the lower active material layer 220 may be substantially the same as the current collector layer 100, the current collector 110, the upper active material layer 210, and the lower active material layer 220 described with reference to FIGS. 1 and 2.

Each of the plurality of features, e.g., 120A, 120B, and 120C, may be substantially the same as the feature 120 described with reference to FIGS. 1 and 2. Each of the plurality of through adhesive patterns e.g., 310A, 310B, and 310C, may be substantially the same as the through adhesive pattern 310 described with reference to FIGS. 1 and 2. In an embodiment, the plurality of through adhesive patterns 310 may be three in number. In an embodiment, the plurality of through adhesive patterns 310 may be two or more. In an embodiment, the plurality of features may be three in number. In an embodiment, the features may be two or more.

The plurality of through adhesive patterns, e.g., adhesive patterns 310A, 310B, and 310C, may pass through the current collector layer 100. The plurality of through adhesive patterns, e.g., through adhesive patterns 310A, 310B, and 310C, may be apart from each other in a direction parallel to the top surface 100u of the current collector layer 100. The plurality of through adhesive patterns, e.g., through adhesive patterns 310A, 310B, and 310C, may be apart from each other in a direction parallel to the top surface 110u of the current collector 110. The bonding force between the upper active material layer 210 and the current collector layer 100 and the bonding force between the lower active material layer 220 and the current collector layer 100 may be increased by the plurality of through adhesive patterns, e.g., through adhesive patterns 310A, 310B, and 310C. Accordingly, the structural stability of the electrode structure 15 may be improved.

In an embodiment, a plurality of upper buried adhesive patterns and a plurality of lower buried adhesive patterns may be provided instead of the plurality of through adhesive patterns. Each of the plurality of upper buried adhesive patterns may be substantially the same as the upper buried adhesive pattern 322 described with reference to FIGS. 3 and 4. Each of the plurality of lower buried adhesive patterns may be substantially the same as the lower buried adhesive pattern 324 described with reference to FIGS. 5 and 6.

The present disclosure can provide an electrode structure 15 having improved structural stability, reduced thickness, and improved electrical conductivity compared to an electrode structure of a nickel-cadmium battery or a nickel-hydrogen battery.

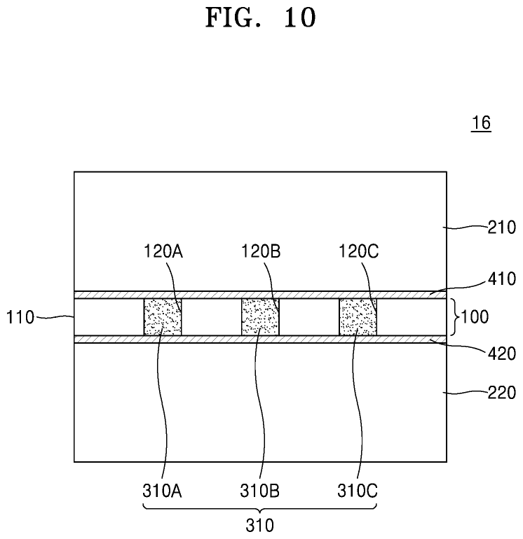

FIG. 10 is a diagram of an electrode structure 16 according to an embodiment. For brevity of description, repetitive description given with reference to FIGS. 1 through 6 may be omitted for clarity.

Referring to FIG. 10, the electrode structure 16 including a current collector layer 100, comprising a current collector 110 comprising a plurality of features, e.g., features 120A, 120B, and 120C, wherein the current collector 110 is within the current collector layer 100, an upper active material layer 210, a lower active material layer 220, an upper conductive layer 410, a lower conductive layer 420, and a plurality of through adhesive patterns, e.g., adhesive patterns 310A, 310B, and 310C, comprising an adhesive and disposed in features 120A, 120B, and 120C, respectively, of the current collector, may be provided. The current collector layer 100, the current collector 110, the upper active material layer 210, and the lower active material layer 220 may be substantially the same as the current collector layer 100, the current collector 110, the upper active material layer 210, and the lower active material layer 220 described with reference to FIGS. 1 and 2.

The upper conductive layer 410 may be provided between the upper active material layer 210 and the plurality of through adhesive patterns, e.g., through adhesive patterns 310A, 310B, and 310C, comprising an adhesive and disposed in the feature of the current collector layer. The upper conductive layer 410 may directly contact the plurality of through adhesive patterns. The lower conductive layer 420 may be provided between the lower active material layer 220 and the plurality of through adhesive patterns. The lower conductive layer 420 may directly contact the plurality of through adhesive patterns.

The plurality of through adhesive patterns, e.g., through adhesive patterns 310A, 310B, and 310C, may extend between the upper conductive layer 410 and the current collector layer 100 by passing through the current collector layer 100. The plurality of through adhesive patterns may extend between the lower conductive layer 420 and the current collector layer 100 by passing through the current collector layer 100.

In an embodiment, a plurality of upper buried adhesive patterns and a plurality of lower buried adhesive patterns may be provided instead of the plurality of through adhesive patterns. Each of the plurality of upper buried adhesive patterns may be substantially the same as the upper buried adhesive pattern 322 described with reference to FIGS. 3 and 4. Each of the plurality of lower buried adhesive patterns may be substantially the same as the lower buried adhesive pattern 322 described with reference to FIGS. 5 and 6.

The present disclosure may provide the electrode structure 16 having improved structural stability, reduced thickness, and improved electrical conductivity compared to an electrode structure of a nickel-cadmium battery or a nickel-hydrogen battery.

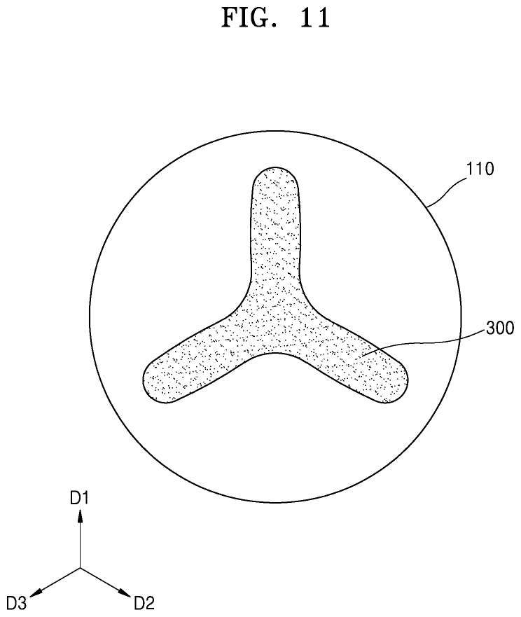

FIG. 11 is a plan view of an embodiment of an adhesive pattern looking down at a top surface of a current collector layer 100, for explaining an adhesive pattern 300 comprising an adhesive and disposed in the feature of the current collector. For brevity of description, substantially the same description as given with reference to FIGS. 1 through 4 may be omitted.

Referring to FIG. 11, the current collector layer 100 and the adhesive pattern 300 comprising an adhesive and disposed in the feature of the current collector layer may be provided. The current collector layer 100, and the current collector 110 may be substantially the same as the current collector layer 100, and the current collector 110 described with reference to FIGS. 1 and 2. The adhesive pattern 300 may be exposed and on a top surface 100u of the current collector layer 100. The adhesive pattern 300 may include three portions, extending in a first direction D1, a second direction D2, and a third direction D3, each of the directions parallel to the top surface 100u of the current collector layer 100. For example, the first direction D1 and the second direction D2, the second direction D2 and the third direction D3, and the third direction D3 and the first direction D1 may extend in a direction of about 120 degrees (°) from each other.

The adhesive pattern 300 may include a through adhesive pattern described with reference to FIGS. 1 and 2 and/or the upper buried adhesive pattern 322 described with reference to FIGS. 3 and 4.

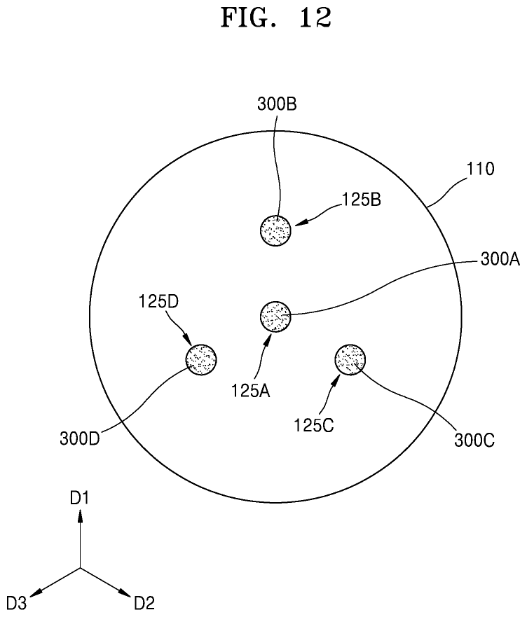

FIG. 12 is a plan view of an embodiment of an adhesive pattern looking down at a top surface of a current collector layer 100, for explaining an adhesive pattern comprising an adhesive and disposed in the feature of the current collector layer. For brevity of description, repetitive description given with reference to FIGS. 1 and 2 may be omitted for clarity.

Referring to FIG. 12, the current collector layer 100 and four adhesive patterns 300A, 300B, 300C, and 300D may be provided. The current collector layer 100, and the current collector 110 may be substantially the same as the current collector layer 100, and the current collector 110 described with reference to FIGS. 1 and 2. For example, the current collector layer 100 may comprise a current collector 110, and the current collector 110 may comprise a feature, e.g., features 125A, 125B, 125C, and 125D. The four adhesive patterns 300A, 300B, 300C, and 300D comprising an adhesive may be disposed in the features 125A, 125B, 125C, and 125D, respectively. The adhesive patterns may be exposed by the top surface 100u of the current collector layer 100.

The four adhesive patterns 300A, 300B, 300C, and 300D may be apart from each other in a direction parallel to the top surface 100u of the current collector layer 100. One of the four adhesive patterns 300A, 300B, 300C, and 300D may be disposed at the center of the current collector layer 100. The other three of the four adhesive patterns 300A, 300B, 300C, and 300D respectively may be apart in a first direction D1, a second direction D2, and a third direction D3 from the adhesive pattern 300A.

The four adhesive patterns 300A, 300B, 300C, and 300D may include the through adhesive pattern described with reference to FIGS. 1 and 2 and/or the upper buried adhesive pattern 322 described with reference to FIGS. 3 and 4.

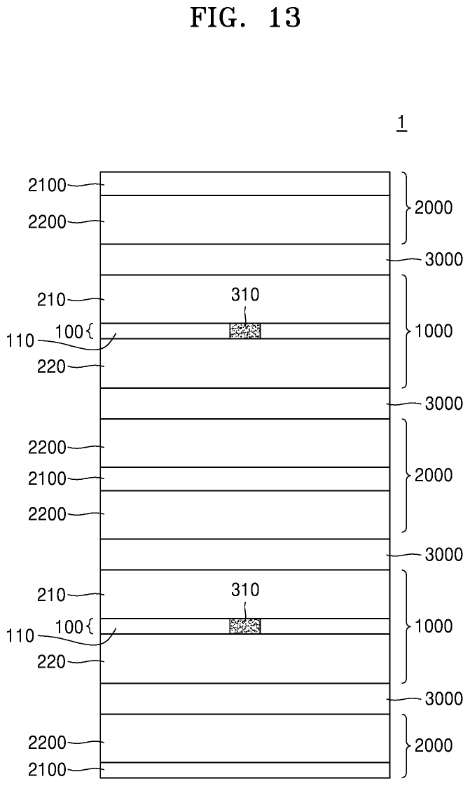

FIG. 13 is a diagram of an embodiment of a secondary battery 1. For brevity of description, substantially the same description as given with reference to FIGS. 1 and 2 may be omitted.

Referring to FIG. 13, the secondary battery 1 including a plurality of cathode structures 1000, a plurality of anode structures 2000, and a plurality of separation films 3000 may be provided. Each of the plurality of cathode structures 1000 may include the electrode structure 11 described with reference to FIGS. 1 and 2. In an embodiment, each of the plurality of cathode structures 1000 may include at least one of the electrode structures 13, 14, 15, and 16 described with reference to FIGS. 5 and 6, 7 and 8, 9, and 10.

Each of the plurality of anode structures 2000 may include an anode current collector layer 2100 and an anode active material layer 2200. The anode current collector layer 2100 may include a conductive metal. For example, the anode current collector layer 2100 may include copper foil, nickel foil, stainless steel foil, titanium foil, nickel foam, copper foam, a polymer substrate coated with a conductive metal, or a combination thereof.

The anode active material layer 2200 may include an anode active material. For example, the anode active material layer 2200 may include a composite material including a material capable of reversibly intercalating/deintercalating lithium ions, a lithium metal, an alloy of lithium metal, a material capable of doping and undoping lithium, a transition metal oxide, etc. The anode active material layer 2200 may further include a binder, a conductive material, and/or a thickener.

The separation films 3000 may be provided between the cathode structures 1000 and the anode structures 2000. The separation films 3000 may be disposed immediately adjacent to the cathode structures 1000 and the anode structures 2000. The separation films 3000 separate the cathode structures 1000 and the anode structures 2000 and provide a passage for moving lithium ions, and may include any suitable separation films that may be used in a lithium battery. That is, any suitable separation films that have low resistance to ion migration of the electrolyte and high electrolyte-wetting ability may be used. For example, the separation films may be selected from glass fiber, polyester, polyethylene (PE), polypropylene (PP), polytetrafluoroethylene (PTFE), or a combination thereof. The separation films 3000 may be in the form of a nonwoven fabric or a woven fabric. In particular, in a lithium ion battery, a polyolefin-based polymer separation film, for example, polyethylene or polypropylene may be used, and a separation film coated with a ceramic component or a polymer material may be used to secure heat resistance or mechanical strength. Optionally, the separation film may be used in a single layer or a multilayer structure.

An electrolyte (not shown) may fill a gap between each current collector layer 100 and the anode current collector layer 2100 of the plurality of cathode structures 1000.

In an embodiment, a solid electrolyte membrane may be provided between the cathode structures 1000 and the anode structures 2000 immediately adjacent to each other. That is, the solid electrolyte membrane may be provided instead of the separation films. When the solid electrolyte membrane 3000 is provided between the cathode structures 1000 and the anode structures 2000, an electrolyte may not be provided.

The present disclosure may provide a secondary battery 1 including a plurality of cathode structures 1000 having improved structural stability, reduced thickness, and improved electrical conductivity compared to a nickel-cadmium battery or a nickel-hydrogen battery.

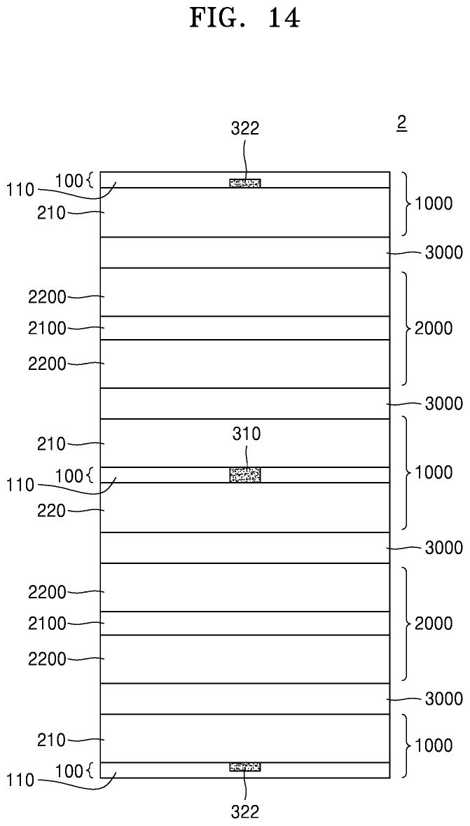

FIG. 14 is a diagram of an embodiment of a secondary battery. For brevity of description, repetitive description given with reference to FIG. 13 is omitted for clarity.

Referring to FIG. 14, a secondary battery 2 including a plurality of cathode structures 1000, a plurality of anode structures 2000, and a plurality of separation films 3000 may be provided.

Unlike the descriptions made with reference to FIG. 13, the cathode structures 1000 respectively may be disposed at the top and bottom of the secondary battery 2. Each of the top and bottom cathode structures 1000 may include the electrode structure 12 described with reference to FIGS. 3 and 4. Each of the top and bottom cathode structures 1000 may include the upper buried adhesive pattern 322.

The present disclosure may provide a secondary battery 2 including a plurality of cathode structures 1000 having improved structural stability, reduced thickness, and improved electrical conductivity compared to a nickel-cadmium battery or a nickel-hydrogen battery.

The present disclosure may provide an electrode structure and a secondary battery having improved electrical characteristics, reduced thickness, and improved structural stability compared to a nickel-cadmium battery or a nickel-hydrogen battery and their electrode structure.

It should be understood that embodiments described herein should be considered in a descriptive sense only and not for purposes of limitation. Descriptions of features or aspects within each embodiment should be considered as available for other similar features or aspects in other embodiments. While an embodiment has been described with reference to the figures, it will be understood by those of ordinary skill in the art that various changes in form and details may be made therein without departing from the spirit and scope as defined by the following claims.

What is claimed is:

1. An electrode structure comprising:
a current collector layer comprising a current collector comprising a feature, wherein the current collector is within the current collector layer;
an active material layer on the current collector layer; and
an adhesive pattern comprising an adhesive and disposed in the feature of the current collector, wherein
the adhesive pattern extends between the current collector layer and the active material layer, and
the active material layer is fixed on a top surface of the current collector layer by the adhesive pattern.

2. The electrode structure of claim 1, wherein a distance between a top surface of the adhesive pattern and a bottom surface of the current collector layer is greater than a thickness of the current collector layer.

3. The electrode structure of claim 1, wherein the adhesive pattern extends from the top surface of the current collector layer in a direction towards a bottom surface of the current collector layer.

4. The electrode structure of claim 1, wherein a maximum width of the adhesive pattern on the top surface of the current collector layer is greater than a maximum width of the adhesive pattern in the feature of the current collector.

5. The electrode structure of claim 1, wherein the adhesive pattern passes through the current collector layer and extends from a top surface of the current collector to a bottom surface of the current collector.

6. The electrode structure of claim 5, wherein the adhesive pattern is between the active material layer and the current collector.

7. The electrode structure of claim 5, wherein the active material layer comprises an upper active material layer and a lower active material layer, wherein
the lower active material layer is on a side of the current collector layer opposite the upper active material layer,
the adhesive pattern extends from the current collector layer to the lower active material layer, and
the lower active material layer is fixed on a bottom surface of the current collector layer by the adhesive pattern.

8. The electrode structure of claim 7, wherein a distance between a bottom surface of the adhesive pattern and the top surface of the current collector layer is greater than a thickness of the current collector layer.

9. The electrode structure of claim 7, wherein at least one of a bottom surface of the upper active material layer and a top surface of the lower active material layer has a corrugated structure.

10. The electrode structure of claim 7, wherein the feature extends through the current collector from the top surface of the current collector to the opposite bottom surface of the current collector.

11. The electrode structure of claim 6, wherein the feature does not extend through the current collector from the top surface of the current collector to the opposite bottom surface of the current collector.

12. The electrode structure of claim 5, wherein the adhesive pattern comprises a first adhesive pattern on the top surface of the current collector and a second adhesive pattern on the bottom surface of the current collector.

13. The electrode structure of claim 1, wherein a thickness of the adhesive pattern is less than the thickness of the current collector layer.

14. The electrode structure of claim 7, wherein
the active material layer comprises the upper active material layer on the top surface of the current collector layer opposite the lower active material layer, and a lower adhesive pattern disposed in the feature of the current collector, wherein
the lower adhesive pattern extends between the current collector layer and the lower active material layer,
a thickness of the lower adhesive pattern is less than the thickness of the current collector layer, and
the lower active material layer is fixed on the bottom surface of the current collector layer by the lower adhesive pattern.

15. The electrode structure of claim 14, further comprising a conductive film on a bottom surface of the upper active material layer.

16. The electrode structure of claim 15, wherein the conductive film conformally extends along the bottom surface of the upper active material layer.

17. A secondary battery comprising:
a separation film;
an anode structure on the separation film; and
a cathode structure on a side of the separation film opposite the anode structure, wherein
the cathode structure comprises
a current collector layer comprising a current collector comprising a feature, wherein the current collector is within the current collector layer;
an active material layer on the current collector layer, and
an adhesive pattern comprising an adhesive and disposed in the feature of the current collector, wherein
the adhesive pattern extends between the current collector layer and the active material layer, and
the active material layer is fixed on the current collector layer by the adhesive pattern.

18. The secondary battery of claim 17, wherein the adhesive pattern extends from a top surface of the current collector layer in a direction towards a bottom surface of the current collector layer.

19. The secondary battery of claim 18, wherein
wherein the active material layer comprises an upper active material layer and lower active material layer,
the lower active material layer is on a side of the current collector layer opposite to the upper active material layer,
the adhesive pattern extends from the current collector layer to the lower active material layer, and
the lower active material layer is fixed on the bottom surface of the current collector layer by the adhesive pattern.

20. The secondary battery of claim 19, wherein a thickness of the adhesive pattern is less than the thickness of the current collector layer.

21. A secondary battery comprising:
a solid electrolyte membrane;
an anode structure provided on the solid electrolyte membrane; and
a cathode structure provided on the solid electrolyte membrane and opposite the anode structure, wherein
the cathode structure comprises
a current collector layer comprising a current collector comprising a feature, wherein the current collector is within the current collector layer;
an active material layer provided on the current collector layer; and
an adhesive pattern comprising an adhesive and disposed in the feature of the current collector, wherein
the adhesive pattern extends between the current collector layer and the active material layer, and
the active material layer is fixed on the current collector layer by the adhesive pattern.

22. The secondary battery of claim 21, wherein
the active material layer comprises an upper active material layer and lower active material layer,
a lower active material layer is on a side of the current collector layer opposite the upper active material layer,
the adhesive pattern extends from the current collector layer to the lower active material layer, and
the lower active material layer is fixed on a bottom surface of the current collector layer by the adhesive pattern.

23. The secondary battery of claim 22, wherein a thickness of the adhesive pattern is less than the thickness of the current collector layer.
